(19) United States
(12) Patent Application Publication
(10) Pub. No.: US 2007/0101728 A1
(43) Pub. Date: May 10, 2007

(54) Device for a steering system, particularly for a motor vehicle

(75) Inventor: Christian Ruetz, Ludwigsburg (DE)

Correspondence Address: DREISS, FUHLENDORF, STEIMLE & BECKER, POSTFACH 10 37 62, D-70032 STUTTGART, DE

(73) Assignee: Valeo Schalter und Sensoren GmbH, Bietigheim-Bissingen (DE)

(21) Appl. No.: 11/589,393

(22) Filed: Oct. 30, 2006

(30) Foreign Application Priority Data
Nov. 3, 2005 (DE) 10-2005 053 182.2

(51) Int. Cl. G05G 1/04; B60H 1/00; B60R 21/16

(52) U.S. Cl. 62/3.61; 280/731; 74/522; 165/41; 454/152

(57) ABSTRACT

The disclosure relates to a device (2) for a steering system for a motor vehicle, comprising a steering wheel (4) with a grip region (6), wherein the grip region (6) has at least one hollow space (44), which is configured such that a temperature-controlled medium can flow through the at least one hollow space.

### CROSS-REFERENCE TO RELATED APPLICATIONS

This application claims the benefit of DE 10 2005 053 182.2, filed Nov. 3, 2005. The disclosure of the above application is incorporated herein by reference.

### FIELD

The present disclosure relates to a device for a steering system for a motor vehicle comprising a steering wheel with a grip region.

### BACKGROUND

The statements in this section merely provide background information related to the present disclosure and may not constitute prior art.

From prior use, steering wheels are known with integrated heating coils. These serve the heating of the grip region of the steering wheel, so that it has a pleasant temperature. The heating coils have the disadvantage that high currents in the range of 7 to 8 A are required to achieve a satisfactory heating effect. For the power supply of the turning steering wheel, clock springs are used, which can be comparatively prone to wear. Furthermore, the clock springs can be a source of undesirable noise.

### SUMMARY

Starting from this, it is the object of the present disclosure to create a device for a steering system for a motor vehicle, which allows temperature control of the steering wheel while foregoing the use of a clock spring.

This object is achieved according to the disclosure in that the grip region comprises at least one hollow space, which is configured such that it allows a heated medium to flow through.

The device, according to the disclosure, offers a series of advantages. The clock springs and heating coils mentioned above can be foregone because the grip region is controlled by means of the medium flowing in the hollow space. At the same time, the medium (for example air or water) can be controlled such that the grip region is either heated or cooled. Unlike a grip region that can be heated with heating coils, this offers the additional possibility of cooling the steering wheel. This is particularly advantageous since surfaces in a motor vehicle interior exposed to direct sunlight can heat up to 100° C. The driver of such an overheated motor vehicle will attempt to stay away from the hot surfaces as much as possible. However, this will not be possible with respect to the steering wheel for driving the motor vehicle.

In a further development of the disclosure, the hollow space is adapted to the geometry of the grip region. This ensures that all regions of the steering wheel with which the hands of the driver of the motor vehicle come in contact will be cooled or heated.

The hollow space can be configured ring-shaped at least in sections to ensure well-distributed cooling and/or heating on steering wheels with a peripheral steering wheel rim.

It is possible within the framework of the disclosure that the hollow space is connected to a feed line and a discharge line for media, so that for example a hot medium is supplied to the hollow space, the heat is emitted to the grip region and the cooler medium can be removed. Accordingly, a cooled medium can be supplied to remove heat from the grip region and again discharge the warmer medium.

However, it is also possible as part of the disclosure that the grip region comprises outwardly directed orifices connected to the hollow space for fluid flow. In this case, the medium, such as air, is supplied via the hollow space to the orifices from which air can exit. This process either cools or heats the grip region of the steering wheel. With a sufficiently strong flow, the medium can cool or heat the motor vehicle driver's hands coming in contact with the grip region at the same time.

The orifices may be disposed in a support body of the grip region. This ensures that the medium can flow from the hollow space to the orifices. The support body may be enclosed by a flow-tight steering wheel cover. This cover can be heated or cooled with the help of the medium by means of contact with the orifices, which are in turn connected to the hollow space.

However, it is also possible that the orifices are provided in a steering wheel cover that encloses the support body at least in sections. In this case, the medium can exit through the steering wheel cover and thus control the temperature of the grip region. With a sufficiently high flow, the driver's hands can be temperature-controlled as well.

The support body and/or the steering wheel cover can be made of an open-pored material. Possible materials are, for example, metal or plastic foams, leather or textiles. Also, the use of membranes is conceivable.

According to one embodiment of the disclosure, the grip region is connected via at least one connecting section to the steering wheel hub of the steering wheel, at least indirectly, wherein in the connecting section at least one line is provided for the temperature-controlled medium, for which line is connected to the hollow space for fluid flow. This way, the hollow space can be supplied with medium in a center region of the steering wheel. As a result, the supply of the hollow space with medium is facilitated.

It is advantageous if the steering wheel hub comprises a particularly ring-shaped distributor disposed upstream of the line of the connecting section in terms of flow. In this case, the medium can be connected to the turning steering wheel and the simultaneously rotating hollow section via a simple feed line, which is permanently connected via the distributor to at least one line of the connecting section. It is also conceivable, however, that the line and/or the hollow space are supplied only in certain steering wheel positions and that no ring-shaped distributor is used.

When the line of the connecting section and, thus, the distributor are supplied by a stationary feed line, the connecting region supplying the steering wheel with medium may comprise rigid lines, thus eliminating flexible hoses, which in principle can also be used.

This stationary feed line may be disposed in a support accommodating the steering wheel hub. As a result, a component that is required anyhow for mounting the steering wheel, at the same time, assumes the function of supplying the grip region with medium. The above-described particularly ring-shaped distributor may be provided additionally or optionally in or on the support.

Advantageously, the stationary feed line and/or the distributor provided in or on the support are sealed by sealing elements in relation to the line of the connecting section and/or the distributor provided in the steering wheel hub. Depending on the medium that is selected, such sealing, however, may not be absolutely necessary. For example, when using air as the medium it is certainly conceivable to allow a certain amount of leakage, for example, if this means that the device can have a simpler design. The use of the aforementioned sealing elements may increase the efficiency of the device. When the medium is supplied to the hollow space as described above and is removed from there, the use of sealing elements ensures that the medium cannot penetrate into the interior of the motor vehicle.

The device may comprise particularly a separate cooling and/or heating system for controlling the temperature of the medium. This way it is possible to exactly adjust the temperature of the grip region. Of course, it is also possible not only to adjust, but also to control the temperature of the medium by using temperature sensors and a control device.

In a particularly advantageous embodiment, the cooling and/or heating device includes the air conditioner or electronic climate control of the motor vehicle. In this case, a separate cooling device is not required for cooling the medium to the desired temperature.

Furthermore, it is very advantageous when the cooling and/or heating device includes the passenger compartment ventilation of the motor vehicle. As a result, the fans and/or air routing ducts, which are provided anyhow for conveying the air, can be coupled to the steering wheel that is supposed to be temperature-controlled, without requiring further elements for conveying the medium.

Additional advantages, characteristics and details of the present disclosure will be apparent from the description with reference to a particularly preferred embodiment that is illustrated in the figures. The characteristics illustrated in the figures and mentioned in the claims, as well as in the description, can be essential for the disclosure either alone or in any random combination.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The figures show:

FIG. 1 a perspective, partially cut view of a device according to the disclosure;

FIG. 2 a rear perspective view of a section of the device according to FIG. 1;

FIG. 3 a section marked in FIG. 1 with III;

FIG. 4 a section marked in FIG. [1] with IV;

FIG. 5 a front view of the steering wheel of the device according to FIG. 1; and

FIG. 6 a section marked in FIG. 5 with VI.

### DETAILED DESCRIPTION

The following description is merely exemplary in nature and is not intended to limit the present disclosure, application, or uses.

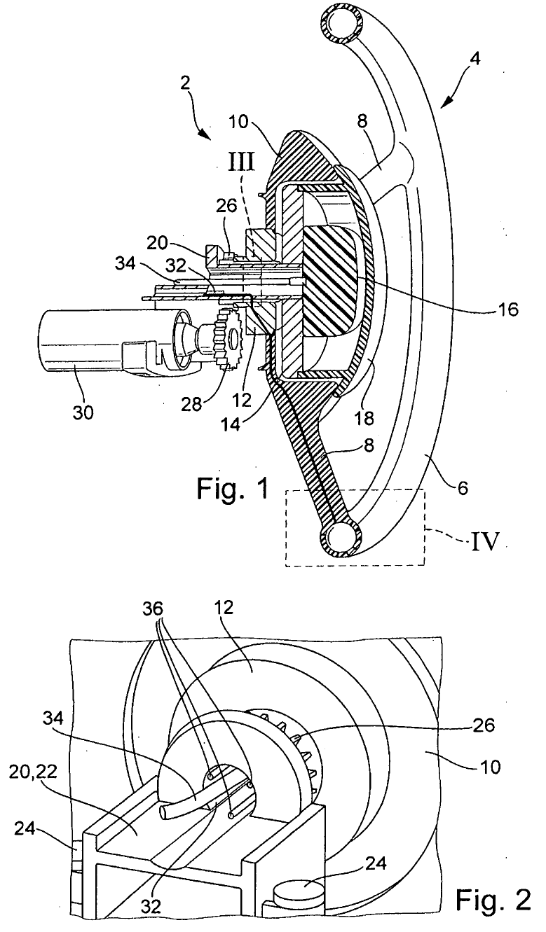

In FIG. 1, a device for a steering system for a motor vehicle has been assigned overall the reference numeral 2. It has a steering wheel 4 with a peripheral grip region 6. The grip region 6 is connected to a centric base body 10 of the steering wheel 4 via connecting sections 8 configured as arms.

The steering wheel 4 or the base body 10 thereof are connected to a steering wheel hub 12. The steering wheel hub 12, as well as a recess provided in the base body 10, serve to accommodate a retainer plate 14 for an air bag 16. It is covered with a cover 18.

The steering wheel hub 12 is mounted rotatably on a support 20 by means of bearings (no reference numeral), which are shown schematically. The support 20 is also illustrated in FIG. 2 and comprises a base 22, which is fastened to the car body structure of a motor vehicle, which is not shown in detail, with fastening elements 24.

The air bag 16 is stationary, meaning it does not rotate along with the steering wheel 4. The air bag 16 is connected to the support 16 via the retainer plate 14. The cover 18 is stationary as well and is connected to the retainer plate 14.

The steering wheel hub 12 is non-rotatably connected to a first gear wheel 26, which combs with a second gear wheel 28, which is, in turn, non-rotatably connected to a steering shaft 30, which is illustrated only in sections.

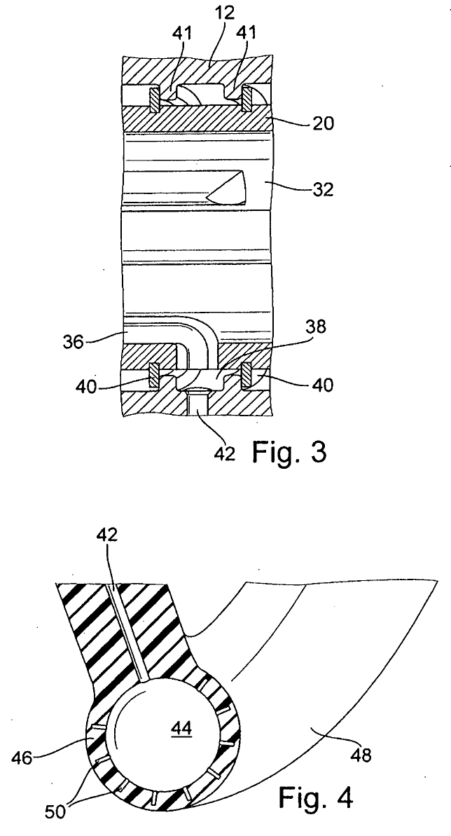

The support 20 comprises a hollow cylindrical section 32 extending in the direction of the air bag 16. Therein, an electrical contact 34 to the air bag 16 is provided. A total of three feed lines 36 for a medium (for example cooling air or heating air), which surround the electrical contact 34, are provided in the hollow cylindrical section 32. The feed lines 36 extend, as is illustrated in FIGS. 1 and 3, parallel to the steering axis of the steering wheel 4 and, on the side facing the steering wheel 4, end radially outward in a ring-shaped distributor 38, which is provided in the steering wheel hub 12. The feed lines 36 and the distributor 38 are mutually sealed by means of annular sealing elements 40. These elements are mounted on the support 20 and interact with ring-shaped bars 41 configured on the steering wheel hub 12.

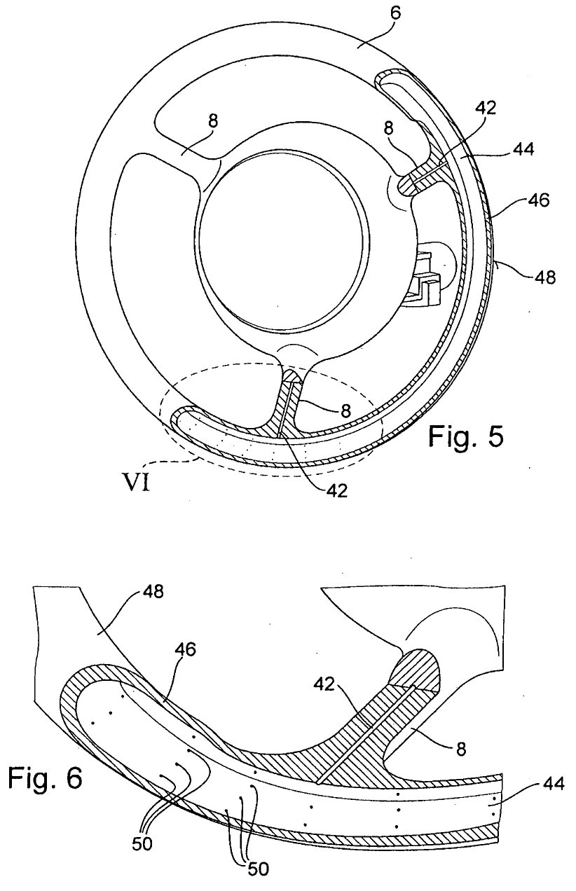

The ring-shaped distributor 38 is connected to the lines 42 for fluid flow, for which lines are provided in the connecting sections 8 of the steering wheel 4. The lines 42 extend from the distributor 38 through the steering wheel hub 12 to the base body 10 and transition from there into the connecting sections 8. The lines 42 join radially outward in a ring-shaped hollow space 44, which is provided in the grip region 6 of the steering wheel 4 (see FIGS. 4 to 6). The grip region 6 comprises a toroidal support body 46, which is enclosed by a steering wheel cover 48. In the support body 46, starting from the hollow space 44, outwardly extending orifices 50 are provided, which end on the air-permeable steering wheel cover 48. The orifices 50 are comparatively small, so that they influence the mechanical stability of the steering wheel 4 only insignificantly. As is apparent particularly from FIG. 4 and FIG. 6, the orifices 50 are provided along a ring, relative to the different angular positions of the steering wheel 4. This ring-shaped distribution of orifices 50 is repeated at regular intervals, for example, every ten degrees.

The feed lines 36 of the device 2 are connected to a passenger compartment ventilation system of the motor vehicle, which system is not shown in detail. This system is, in turn, connected to an air conditioner or electronic climate control of the motor vehicle, which is not shown. Via feed lines 36, the cooled or heated air can be supplied to the distributor 38, the lines 42 and the hollow space 44. From there, the air reaches the area of the grip region 6 via the orifices 50.

The device 2 allows the temperature of the grip region 6 of a steering wheel 4 to be controlled, meaning cooled or heated, as desired by the driver of the motor vehicle.

What is claimed is:

1. A device for a steering system for a motor vehicle, comprising a steering wheel with a grip region, characterized in that the grip region has at least one hollow space, which is configured such that a temperature-controlled medium can flow through the at least one hollow space.

2. A device according to claim 1, characterized in that the hollow space is adapted to a geometry of the grip region.

3. A device according to claim 1, characterized in that the hollow space has a ring shape at least in sections.

4. A device according to claim 1, characterized in that the grip region comprises outwardly directed orifices, which are connected to the hollow space for fluid flow.

5. A device according to claim 4, characterized in that the orifices can be provided in the support body of the grip region.

6. A device according to claim 4, characterized in that the orifices are provided in a steering wheel cover enclosing the support body at least in sections.

7. A device according to claim 4, characterized in that the support body and/or the steering wheel cover are made of an open-pored material.

8. A device according to claim 1, characterized in that the grip region is connected at least indirectly to the steering wheel hub of the steering wheel via at least one connecting section and that at least one line for the temperature-controlled medium is provided in the connecting section, for which a line is connected to the hollow space for fluid flow.

9. A device according to claim 8, characterized in that the steering wheel hub comprises a particularly ring-shaped distributor, which is disposed upstream of the line of the connecting section in terms of fluid flow.

10. A device according to claim 8, characterized in that the line of the connecting section and/or the distributor are supplied by a stationary feed line.

11. A device according to claim 10, characterized in that the stationary feed line is provided in a support accommodating the steering wheel hub.

12. A device according to claim 11, characterized in that the support comprises a particularly ring-shaped distributor, which is disposed upstream of the line of the connecting section in terms of fluid flow.

13. A device according to claim 10, characterized in that the stationary feed line and/or the distributor of the support are sealed by sealing elements in relation to the line of the connecting section and/or the distributor of the steering wheel hub.

14. A device according to claim 1, characterized in that the device comprises a cooling and/or heating device for controlling the temperature of the medium.

15. A device according to claim 14, characterized in that the cooling and/or heating device includes the air conditioner or electronic climate control of the motor vehicle.

16. A device according to claim 14, characterized in that the cooling and/or heating device includes the passenger compartment ventilation system of the motor vehicle.

17. A device according to claim 1, characterized in that the device comprises a stationary air bag that does not rotate along with the steering wheel.

18. A device according to claim 17, characterized in that the air bag is connected to the support accommodating the steering wheel hub.

19. A device for a steering system for a motor vehicle, comprising a steering wheel with a grip region, characterized in that the grip region has at least one hollow space, which is configured such that a temperature-controlled medium can flow through the at least one hollow space, and the hollow space is adapted to a geometry of the grip region.

20. A device for a steering system for a motor vehicle, comprising a steering wheel with a grip region, characterized in that the grip region has at least one hollow space, which is configured such that a temperature-controlled medium can flow through the at least one hollow space, and the grip region is connected at least indirectly to a steering wheel hub of a steering wheel via at least one connecting section and that at least one line for the temperature-controlled medium is provided in the connecting section, for which a line is connected to the hollow space for fluid flow.
